(19) United States
(12) Patent Application Publication
(10) Pub. No.: US 2013/0022506 A1
(43) Pub. Date: Jan. 24, 2013

(54) AIR PURIFICATION EQUIPMENT

(71) Applicants: Eusebio Moro Franco, L'Alcora (Castellon) (ES); Maria Asunción Gallart Grau, L'Alcora (Castellon) (ES)

(72) Inventors: Eusebio Moro Franco, L'Alcora (Castellon) (ES); Maria Asunción Gallart Grau, L'Alcora (Castellon) (ES)

(21) Appl. No.: 13/478,303

(22) Filed: May 23, 2012

Related U.S. Application Data
(63) Continuation of application No. PCT/ES2010/070562, filed on Aug. 19, 2010.

(30) Foreign Application Priority Data
Nov. 24, 2009 (ES) P200931042

(51) Int. Cl. B01D 53/00; B01D 53/30

(52) U.S. Cl. 422/121; 55/472; 55/282.3; 55/428; 96/224; 96/417; 422/122

(57) ABSTRACT

The invention relates to an air cleaning device essentially comprising at least a vertical hollow structure having a first perforated side surface forming an inlet (1-2) for the air to be cleaned and a second perforated side surface forming an outlet (3-4) for the cleaned air. The invention is characterized in that the vertical hollow structure is covered with a protective cover and decorative elements (15) are positioned outside said cover in order to conceal the vertical hollow structure completely or partially. The structure contains filter units, as well as a fan (6-7) that forces the passage of air between the air inlet and the air outlet, thereby eliminating impalpable components and preventing a reaction with impure gases which are also eliminated.

### OBJECT OF THE INVENTION

The present invention, as expressed in the statement of this specification, relates to an air purification equipment basically comprising a supporting structure which incorporates filtering units in its interior that are arranged between a dirty air inlet and a clean air outlet, whose impurities have been neutralized and retained by the aforementioned filtering units. The invention is used to purify the external environment, especially the urban environment, such as, for example, park areas, highways, roundabouts, etc.

Based on this premise, the object of the invention is an air purification equipment hidden behind certain external pieces that are part of a decorative or sculptural motif or one that is adapted to the structure of an urban billboard or advertising column-type urban element, among others, so that the equipment incorporates typical filtering units, as well as other particular elements, with the particularity that the draught inside the equipment travels along a vertical path.

### BACKGROUND OF THE INVENTION

Nowadays several air purification equipment are known, which are designed to purify air in internal spaces so that in all cases, the dirty air enters through an inlet mouth and exits through an outlet mouth, and the particles are retained inside said equipment by means of different filtering units.

### DESCRIPTION OF THE INVENTION

The air purification equipment that constitutes the object of the invention is determined from a vertical hollow structure, characterized in that it comprises at least one air purification column that incorporates a perforated lateral surface with a multitude of orifices as the inlet for the air to be purified and another lateral surface, that is also perforated, as the outlet for the cleaned air, whose impurities have been neutralized and retained inside the equipment of the invention by means of at least one lower filtering unit interspersed between the air inlet and the outlet.

Therefore, depending on the quality of the air being treated, one or several air purification columns will be set out, by dimensioning the equipment of the invention conveniently. The air purification column or columns are covered by means of a protective cover and a statue, a piece of street furniture, an advertising covering, a sculpture, etc., is set out over the protective cover.

Another characteristic of the invention is that the interior of the vertical structure of the equipment of the invention incorporates at least one fan to force the passage of air through the different filtering units, thus achieving a greater performance and effectiveness in the filtration and retention of particles.

Based on this premise, in a first embodiment, the air inlet is normally found in a lower area and the outlet is normally found in an upper area.

In this first embodiment, there are centred filter units (filtering plates) that are each set out in the respective extractable trays, and said centred filter units comprise materials and/or catalysts to neutralize the noxious compounds that are not collected by the lower filtering unit set out in front of the air inlet. Said noxious compounds refer, for example, to CO₂, NOₓ, COVₓ. Therefore, the air enters through the lower part and then ascends through the group of filter units, which eliminate the impalpable components from circulation and the reaction with the impure gases (elimination).

Another characteristic of this first embodiment is that the lower filtering unit may incorporate a heating element to burn the collected particles, thus improving performance and also eliminating the most noxious particles.

In a second embodiment, the trays and their corresponding centred filter units are dispensed with and are replaced by an upper filtering unit; then, in this second embodiment, the fan is located in a central area between said upper filtering unit and the lower filtering unit.

In addition, in this second embodiment, the entry of air is carried out through the upper part and the exit through the lower part.

On the other hand, the possibility of incorporating a UV-ray emitting source, located behind the air outlet, has been envisaged.

In a third embodiment, the possibility of a horizontal arrangement of the equipment of the invention has been contemplated, to be adapted to tunnels or areas so requiring it, such as, for example, an arrangement similar to the arrangement of exhaust fans in said tunnels.

Next, in order to achieve a better comprehension of this specification and being an integral part thereof, certain figures by way of illustration and not by way of limitation accompany this specification.

### BRIEF DESCRIPTION OF THE DRAWINGS

FIG. 1.—Shows a frontal view of the air purification equipment object of the invention.

FIG. 2.—Shows another frontal view of the equipment of the invention, with more elements incorporated.

FIG. 3.—Shows another view of the equipment, according to an embodiment other than the one shown in the previous figures.

FIG. 4.—Shows another view of the equipment, with sculptural elements incorporated.

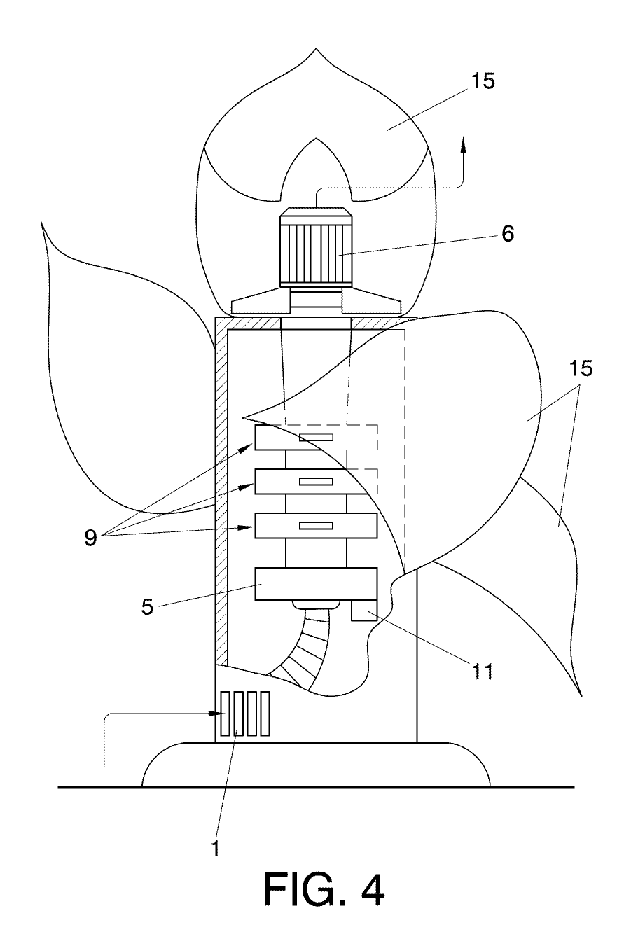

### DESCRIPTION OF THE PREFERRED EMBODIMENT

Taking into account the numeration adopted in the figures, the air purification equipment comprises a hollow vertical structure that incorporates a first perforated lateral surface with a multitude of orifices as the inlet 1-2 for the air to be purified and a second lateral surface, also perforated, as the outlet for the cleaned air 3-4, whose impurities have been retained and neutralized inside the equipment of the invention by means of at least one lower filtering unit 5 and other filtering units that will be defined thereafter, according to two different embodiments.

A fan 6-7 is also incorporated in the interior of the equipment of the invention with the purpose of achieving a greater effectiveness and performance during filtration.

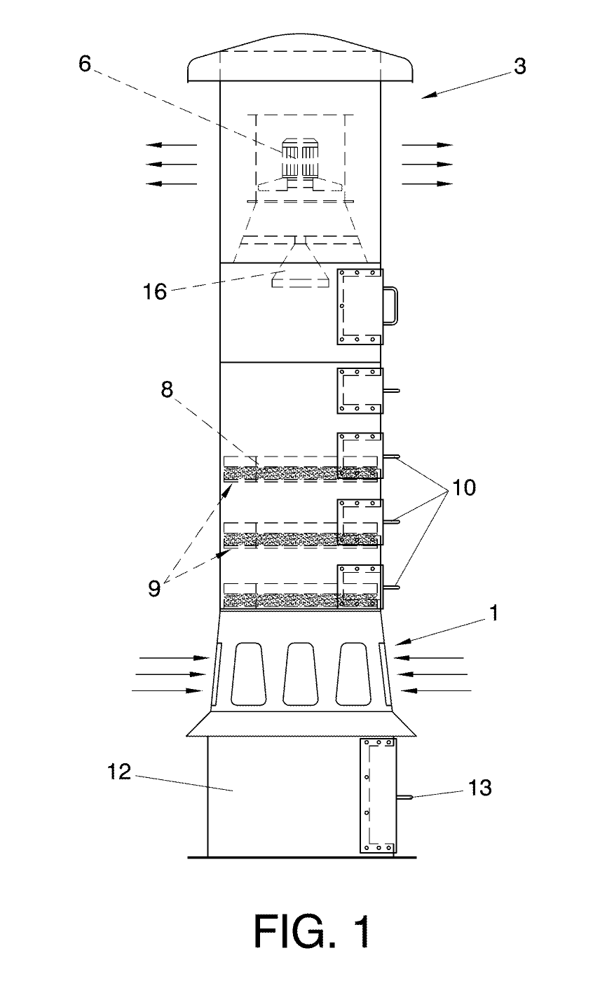

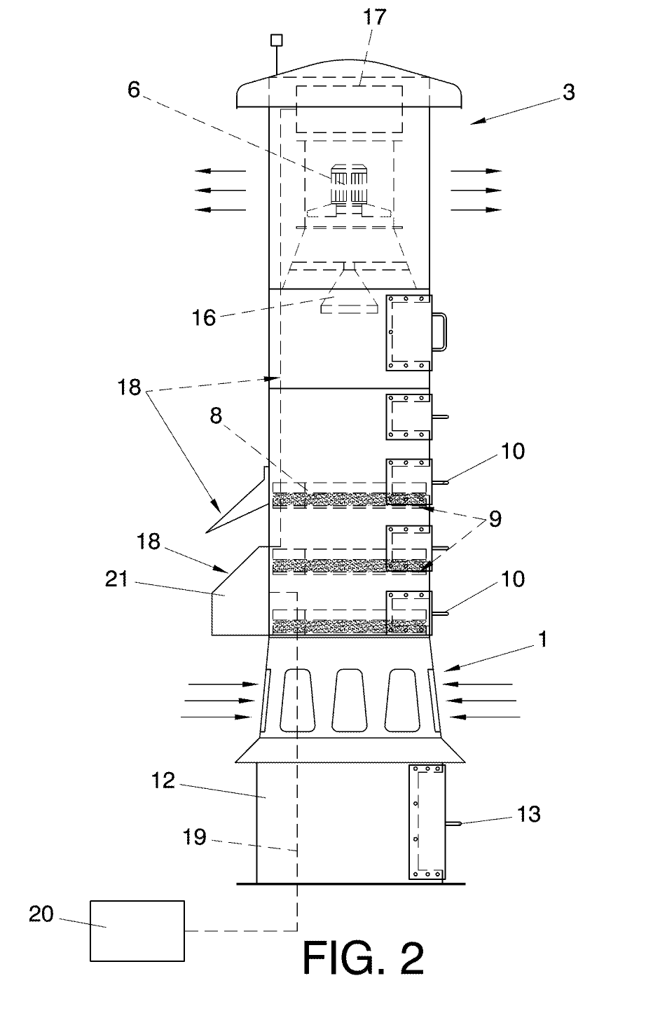

In a first embodiment, shown in FIGS. 1 and 2, the air inlet 1 is located in a lower area, while the air outlet 3 is located in an upper area. The fan 6 is located in correspondence with said air outlet 3, while the lower filtering unit 5 is placed in correspondence with the air inlet 1.

In this first embodiment, there are centred filter units 8 (filtering plates) inside the vertical hollow structure, which are supported by the respective extractable trays 9, arranged in different heights and facing lateral access lids 10 to remove and/or introduce said extractable trays 9 supporting the centred filter units 8.

The filter units 8, supported by the extractable trays 9, comprise materials and/or catalysts to neutralize the noxious components that are not collected by the lower filtering unit 5.

On the other hand, the lower filtering unit 5 incorporates a heating element 11 (FIG. 1) to burn the collected particles, thus improving the performance and eliminating the most noxious particles in this manner.

In this first embodiment described, there is a deposit 12, located in the lowest part of the vertical structure, under the lower filtering unit 5, to collect some of the particles fallen off due to gravity, incorporating said deposit 12 a frontal access lid 13.

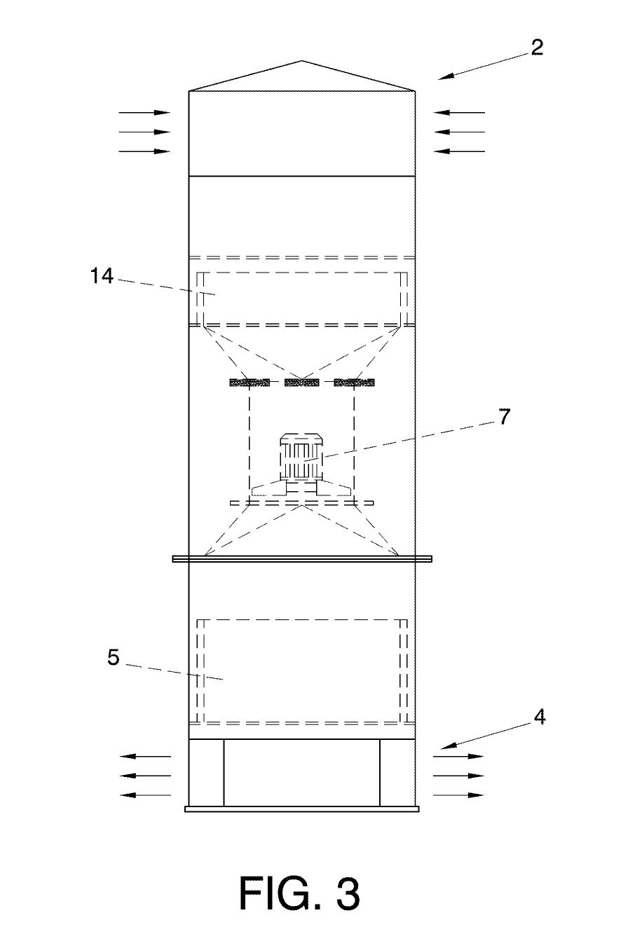

In a second embodiment, shown in FIG. 3, the air inlet 2 corresponds to the upper perforated surface, while the air outlet 4 corresponds to the lower perforated surface.

In addition, in this second embodiment, the trays and the filtering units supported by said trays are dispensed with, and are replaced by the corresponding fan 7 and also by an upper filtering unit 14, complemented by the lower filtering unit 5.

The sculptural equipment of the invention as a whole, in its two versions, is hidden behind external decorative pieces 15, which make up a decorative sculpture per se.

Preferably in the second embodiment, the equipment of the invention incorporates a UV-ray emitting source 16 located behind the upper air outlet 2. This ultraviolet (UV) radiation improves the elimination of pollutants because it is a method of advanced oxidation or photocatalysis.

The equipment of the invention also incorporates an analysing system 17 to control air quality after purification by means of sensors, a computer system 18 to provide real-time information for various uses (street use, information, Internet, cultural information, etc.), a communication 19 with a remote base station 20 to send and receive data and an interactive screen 21, to operate the equipment.

On the other hand, in a preferred embodiment, the compounds of the reagents to be used are applied using known techniques, such as dry application. Thus, a collecting compound and another photocatalyst compound will be used, which are both incorporated in the filtering units according to the example described below.

Thus, in the first place, every 10 kg of collecting compound comprises the following elements with the weight and volume proportions indicated below:
4 kg of CaCl_{2.}
3.14 kg of sepiolite.
2.86 kg of NaOH scales.

10 litters of acetone are added to this mixture, which is mixed or grinded until a paste is formed. This content is dried on trays (2 kg of the mixture per tray, in a well-ventilated area). In a subsequent step, the dried lumps are manually crumbled.

Finally, the obtained collecting compound is deposited as a powder over the filtering units.

Secondly, the photocatalyst compound for the elimination of NOₓ comprises, per each load of 2 kg of photocatalyst compound, the following elements according to the weight proportions indicated below:
3 kg of titanium isopropoxide.
2.2 kg of TEOS.
0.6 kg of copper phtalocyanine.

This mixture is shaken for one hour and is then dried on trays (deposit 0.5 kg per tray in a well-ventilated area). Afterwards, the dried lumps are manually crumbled and finally the obtained photocatalyst compound is deposited as a powder over the filtering units.

1-15. (canceled)

16. Air purification equipment, which, comprising at least one vertical hollow structure that incorporates a first perforated lateral surface as an inlet (1-2) of the air to be cleaned and a second perforated lateral surface as an outlet (3-4) of the cleaned air, is characterized in that said vertical hollow structure is covered by means of a protective cover, outside of which decorative elements (15) that hide said vertical hollow structure totally or partially, are set out; filtering units, as well as a fan (6-7) forcing the passage of air between the air inlet and outlet, are incorporated in the interior of the structure, thus eliminating the impalpable components and the reaction with the impure gases, the air inlet (1) being located in a lower part of the vertical hollow structure while the air outlet (3) being located in an upper area of the vertical hollow structure, in correspondence with which the fan (6) is located, and the vertical hollow structure incorporates a lower filtering unit (5) and centred filter units (8) supported by respective extractable trays (9), arranged at different heights and facing lateral access lids (10).

17. Air purification equipment according to claim 16, characterized in that the centred filter units (8) comprise materials and/or catalysts to neutralize the noxious components that are not collected by the lower filter unit (5).

18. Air purification equipment according to claim 16, characterized in that the air inlet (2) corresponds with an upper perforated surface, while the air outlet (4) corresponds with a lower perforated surface, incorporating in addition an upper filtering unit (14) and a lower filtering unit (5), while the fan (7) is set out in a central area between the lower (5) and the upper (4) filtering units.

19. Air purification equipment according to claim 16, characterized in that the lower filtering unit (5) incorporates a heating element (11) to burn collected particles.

20. Air purification equipment according to claim 16, characterized in that it incorporates a lower deposit (12) set out in the lowest part of the vertical hollow structure that collects particles due to gravity, incorporating a frontal access lid (13).

21. Air purification equipment according to claim 16, characterized in that it incorporates a UV-ray emitting source (16) located behind the upper air outlet (2).

22. Air purification equipment according to claim 18, characterized in that it incorporates a UV-ray emitting source located behind the lower air outlet.

23. Air purification equipment according to claim 16, characterized in that it also includes:
an air analysing system (17) having sensors to control the quality of the purified air;
a computer system (18) to provide real-time information for various uses;
a communication (19) with a remote base station (20) to send and receive data;
an interactive screen (21) to operate the equipment.

24. Air purification equipment according to claim 16, characterized in that some of the filtering units incorporate dry application reagents determined by a collecting compound and a photocatalyst compound to eliminate NO_{X}, both in powder form.

25. Air purification equipment according to claim 24, characterized in that the collecting compound comprises a collecting material that includes:
CaCl_{2.};
sepiolite.
NaOH scales;
acetone, to then mix or grind the mixture until a paste is formed and then dry and crumble the dry lumps afterwards.

26. Air purification equipment according to claim 24, characterized in that the catalyst compound, the photocatalyst compound comprises:
Titanium isopropoxide;
TEOS;
Copper phtalocyanine;
and this mix is shaken for a period of time to then proceed to dry and crumble the dry lumps.

27. Air purification equipment according to claim 25 characterized in that every 10 kg of collecting material comprises:
between 3 and 5 kg of CaCl₂;
between 2.5 and 4.5 kg de sepiolite;
between 1.5 and 3.5 kg of scales;
between 8 and 12 litters of acetone.

28. Air purification equipment according to claim 26 characterized in that every 2 kg of catalyst compound includes:
between 2 and 4 kg of titanium isopropoxide
between 1.5 and 3 kg of TEOS;
between 0.4 and 1 kg of copper phtalocyanine;

29. Air purification equipment according to claim 17, characterized in that the lower filtering unit (5) incorporates a heating element (11) to burn collected particles.

30. Air purification equipment according to claim 18, characterized in that the lower filtering unit (5) incorporates a heating element (11) to burn collected particles.

31. Air purification equipment according to claim 17, characterized in that it incorporates a lower deposit (12) set out in the lowest part of the vertical hollow structure that collects particles due to gravity, incorporating a frontal access lid (13).

32. Air purification equipment according to claim 18, characterized in that it incorporates a lower deposit (12) set out in the lowest part of the vertical hollow structure that collects particles due to gravity, incorporating a frontal access lid (13).

33. Air purification equipment according to claim 17, characterized in that it incorporates a UV-ray emitting source (16) located behind the upper air outlet (2).

34. Air purification equipment according to claim 17, characterized in that it also includes:
an air analysing system (17) having sensors to control the quality of the purified air;
a computer system (18) to provide real-time information for various uses;
a communication (19) with a remote base station (20) to send and receive data;
an interactive screen (21) to operate the equipment.

35. Air purification equipment according to claim 18, characterized in that it also includes:
an air analysing system (17) having sensors to control the quality of the purified air;
a computer system (18) to provide real-time information for various uses;
a communication (19) with a remote base station (20) to send and receive data;
an interactive screen (21) to operate the equipment.

36. Air purification equipment according to claim 17, characterized in that some of the filtering units incorporate dry application reagents determined by a collecting compound and a photocatalyst compound to eliminate NO_{X}, both in powder form.

37. Air purification equipment according to claim 18, characterized in that some of the filtering units incorporate dry application reagents determined by a collecting compound and a photocatalyst compound to eliminate NO_{X}, both in powder form.

38. Air purification equipment according to claim 17, characterized in that the catalyst compound, the photocatalyst compound comprises:
Titanium isopropoxide;
TEOS;
Copper phtalocyanine;
and this mix is shaken for a period of time to then proceed to dry and crumble the dry lumps.

39. Air purification equipment according to claim 18, characterized in that the catalyst compound, the photocatalyst compound comprises:
Titanium isopropoxide;
TEOS;
Copper phtalocyanine;
and this mix is shaken for a period of time to then proceed to dry and crumble the dry lumps.
